(19) United States
(12) Patent Application Publication
(10) Pub. No.: US 2019/0299229 A1
(43) Pub. Date: Oct. 3, 2019

(54) AUTOMATIC HVLP PAINT SPRAY GUN

(71) Applicant: Michael H. Bunnell, Plymouth, MI (US)

(72) Inventor: Michael H. Bunnell, Plymouth, MI (US)

(21) Appl. No.: 16/295,216

(22) Filed: Mar. 7, 2019

Related U.S. Application Data
(60) Provisional application No. 62/649,710, filed on Mar. 29, 2018.

(51) Int. Cl. B05B 7/00; B05B 7/06

(52) U.S. Cl. CPC B05B 7/0081; B05B 7/1218; B05B 7/066

(57) ABSTRACT

An automatic HVLP paint spray gun utilizes turbine air atomizing the paint as it is discharged from a central nozzle, as well as for fanning the paint. The turbine air for fanning or the fanning turbine is directed at the paint after it issues through a paint discharge port disposed centrally of the gun. The utilization of turbine air for both atomizing and fanning provides a paint spray gun which operates between ¼ psi up to about 10 psi.

### CROSS-REFERENCE TO RELATED APPLICATION

This application is a completion application of co-pending U.S. Provisional Patent Application Ser. No. 62/649,710 for “Automatic HVLP Paint Spray Gun,” filed on Mar. 29, 2018, the entire disclosure of which is hereby incorporated by reference, including the drawings.

### BACKGROUND OF THE INVENTION

### 1. Field of the Invention

The present invention pertains to an automatic HVLP paint spray gun for use with stationary setups, varying automation setups, plus industrial robots methods in order to deliver various volumes of paint output at a low air cap pressure and in particular to a turbine air system for delivering air to a spray head with shaping orifices to provide both atomizing and fanning of paint, individually, in order to reduce the turbulence of fanning air to more effectively control the shaping of a conical paint spray pattern.

### 2. Description of the Prior Art

In conventional paint spray guns, a stream of paint under pressure is discharged from a relatively small orifice in a nozzle while air under pressure is discharged radially inwardly into the stream from an annular opening surrounding the nozzle closely adjacent the paint discharge orifice to atomize the stream of paint into a spray of fine particles. The spray produced moves away from the gun in an expanding conical pattern whose apex is at the nozzle.

It is frequently desired to modify the circular cross-section of the normal conical spray pattern by transforming this pattern into one of a narrowed and elongated generally elliptically shaped cross-section so that the spray pattern more closely resembles that of a flat sided fan.

Conventionally, fanning of the spray pattern is accomplished by providing a pair of diametrically opposed ports on the front of the air cap spaced radially outwardly from opposite sides of the annular air discharge opening. The diametrically opposed ports are oriented to direct air jets toward opposite sides of the spray pattern at a location spaced a short distance forwardly from the nozzle orifice. These jets have the effect of flattening the sides of the conical spray pattern against which they are directed. At any given distance from the nozzle, this action transforms the normally circular cross-section of the conical spray into a generally elliptically shaped cross-section. The major axis of the conical spray is somewhat greater than the original cone diameter, and the minor axis of the conical spray is somewhat less than the original cone diameter. The elliptical cross-section becomes more flat with an increase of the air pressure from the diametrically opposed fanning ports.

Conventionally, adjustment of the fanning of the paint spray is accomplished by either rotatably adjusting the air cap (turbine powered low pressure guns) or through an adjustment valve (high pressure guns). A valve stem is adjusted by a thumb screw to restrict the flow of compressed air into a second passage connected to the fanning ports on the air cap.

Conventional automatic guns have a separate air supply that can adjust the flow independent of the thumb screw. This adjustment exerts a valving action which establishes maximum air flow when the diametrically opposed valve ports lie in either a vertical plane containing the nozzle axis or a horizontal plane containing the nozzle axis. The flow through the fanning air ports is reduced as the air cap is rotated, and the fanning air flow is cut off when the fanning air ports are midway between the horizontal and vertical positions referred to above. When the fanning air ports are at this midway position, the paint spray assumes its original conical form.

While the foregoing arrangement provides for adjustment of the fanning air to the paint spray, this adjustment is dependent upon the rotated position of the air cap about the nozzle axis. Adjustment of the fan width (minor axis of the elliptical fan cross-section) to a width between maximum or unmodified conical spray and minimum width requires the ports of the air cap to be disposed in a general plane inclined from the vertical. This inclination of the fanning air ports establishes the angle that the major axis of the elliptical configuration will assume with respect to the vertical, a situation which is inconvenient to the operator who would prefer that this major axis be either vertical or horizontal for all degrees of fanning.

Paint spray guns are disclosed in U.S. Pat. No. 4,744,518, issued May 17, 1988 and U.S. Pat. No. 5,080,285, issued Jan. 14, 1992, each issuing to Toth, which patents are specifically incorporated herein by reference, including the drawings thereof.

In particular, Toth U.S. Pat. No. 5,080,285 discloses two spray gun embodiments, a first embodiment wherein compressor air is used for fanning and turbine air is used for atomizing, and a second embodiment wherein turbine air is used for both fanning and atomizing. The arrangement using turbine air for both atomizing and fanning functions is believed to have been suitable for the purposes then intended and the paint employed in the process.

In each of these Toth embodiments, turbine air is introduced at the forward end of the spray gun and used for atomizing paint spray discharged from the center of the air cap, resulting in a conical spray. Fanning air is introduced at the rearward end of the spray gun.

However, in the second Toth embodiment, turbine air replaces the compressed air for fanning the discharge spray. The turbine air for fanning is introduced at the rear end of the gun and is then split into two portions, one portion of the turbine air being delivered to the rearward end of the gun and associated with a slidable needle valve for adjusting atomizing flow through a nozzle in the center of the air cap at the forward end of the gun and the other portion of the turbine air being delivered to diametrical ports in the air cap at the requisite velocity and directed at opposite sides of a conical spray for fanning paint discharged from the nozzle in the air cap.

One problem with such prior art paint spray guns is that the air discharged from the fanning ports fail to uniformly flatten the sides of the conical spray pattern against which they are directed and, consequently, do not properly control the shape of the spray pattern. This is caused by turbulence of the fanning air and is especially troublesome in paint spray systems where the atomizing air has a flow rate in excess of 5 cfm at the spray head and a delivery pressure of less than 15 psi over atmospheric pressure at the spray head.

Additionally, the pressure and velocity of the paint delivered and available to the air cap at the forward discharge end of the gun needed for fanning might not be optimal in that the rearwardly introduced turbine air may experience a pressure drop and the resultant pressure at the diametrical air ports of the air cap for fanning in some paint applications might be low and cause the paint to splatter, lead to waste, or produce an inefficient spraying application.

Another problem with such guns is that the atomizing air may not properly atomize the paint spray and thus fanning assistance may provide a suitable paint spray.

Another problem with the former HLVP spray gun is that the diversion of fanning air requires a complicated internal gun structure that is inefficient and costly to manufacture.

An object of the present invention is to provide a spray gun including turbine air supply means in fluid communication with passages of the spray gun for supplying turbine air to an air cap or spray head for both atomizing and fanning paint discharged from the air cap air in a manner that reduces the turbulence of the fanning air to more effectively control the shaping of a conical spray pattern created by the turbine air when atomizing and fanning the paint discharged from a central nozzle of the air cap.

Another object of the present invention is to provide a spray gun including turbine means for reducing the turbulence of fanning air wherein the fanning air is derived from pressurized turbine air having a flow rate of 2-20 cfm at the spray head of the gun and a delivery pressure of about 1-10 psi over atmospheric pressure.

Yet another object of the present invention is an automatic HVLP paint spray gun having an improved turbine air delivery system which increases the velocity of turbine air delivered to discharge ports at the discharge end of an air cap for fanning and corresponding shaping of the atomized paint spray.

A further object of this invention is an improved fanning arrangement wherein air jets direct warm turbine air toward opposite sides of a conical spray pattern discharged from a center nozzle of the air cap wherein to flatten the sides of the conical spray.

Yet another object of the present invention is provision of an improved HVLP paint spray gun configured to disperse paint into sufficiently small droplets without forming overspray, thereby decreasing paint consumption and improving the efficiency of paint sprayed onto an object being painted.

Another object of this invention is the provision of an HVLP spray gun that simplifies the structural elements needed to provide fanning air to the air cap, such as by dedicating fanning air solely for fanning and locating a turbine air inlet for fanning proximate the air cap and in opposed relation to the turbine air inlet for the atomizing function.

A further object of the invention is an improved arrangement of the air passages within the gun body, thereby obviating poor internal air flow efficiency and ensuring that more of the paint is actually transferred to the object being painted instead of being wasted.

### SUMMARY OF THE INVENTION

The high volume/low pressure (“HVLP”) spray gun system of the present invention uses turbine air for both atomizing and fanning of the paint discharge.

As used herein, turbine air is supplied to the paint spray gun at less than about 10 psi, at up to 20 about cfm, and at temperatures higher than ambient temperature of from about 5° to about 235° F.

An advantage of turbine air and their respective locations forwardly of the gun proximate to the air cap is that the atomizing air supplied to the paint spray is not as turbulent as high pressure compressed air resulting in an improved transfer efficiency of paint and the fanning air enhances more effective transfer of paint to the object being painted.

The low pressure/high volume concept results in the improved transfer efficiency of the paint spray gun of the subject invention. Transfer efficiency is defined as the ratio of the paint deposited on the product as compared with the paint used. The transfer efficiency of the paint spray gun of the subject invention is in the range of about 65 to about 95%.

The automatic spray gun of the present invention is for industrial applications involving all uses whether stationary, rotating, spinning or with various other types of industrial robots. The spray gun comprises a housing including a tubular extension; an air cap mountable onto the tubular extension of the housing; a source of turbine air for delivering air to the air cap; and means for adjusting the flow of air through the housing independent of the air cap, the air cap including a central nozzle for discharging paint, an opening centered with the nozzle for directing turbine air at the discharged paint whereby to form a conical spray, and a pair of ports that direct turbine air at the paint discharged from the nozzle.

The paint is supplied under pressure to a central paint discharge opening in the nozzle through a first passage. The nozzle has a paint discharge orifice for discharging paint under pressure in a direct stream. The first passage is essentially centrally disposed within the tubular extension.

Turbine air for atomizing is supplied to the discharge opening through a second passage to control the atomizing of the paint spray. The second passage is supplied through an annular chamber in the tubular extension, the annular chamber being disposed radially outwardly from the first passage.

The atomizing air is supplied to the paint spray gun at a temperature higher than ambient temperature and at a pressure of less than 10 psig. The temperature of the atomizing air delivered to the discharge orifice is higher than the temperature of the atomizing air being supplied to the paint spray gun.

Turbine air for fanning air is supplied to discharge openings through at least one third passage in the tubular extension, radially outwardly from the annular chamber, the fanning air controlling the fanning of the atomized conical paint spray. The velocity of the fanning air increases as it passes through the third passage.

For a more complete understanding of the storage system and method of the present invention, reference is made to the following detailed description and accompanying drawings in which the presently preferred embodiment of the invention is illustrated by way of example.

As the invention may be embodied in several forms without departing from the spirit or essential characteristics thereof, it is expressly understood that the drawings are for purposes of illustration and description, only, and are not intended as a definition of the limits of the invention.

Throughout the following description and drawings, identical reference numbers refer to the same component throughout the several views.

### BRIEF DESCRIPTION OF THE DRAWING

FIG. 1 is a perspective view of an automatic HLVP paint spray gun embodying the present invention hereof.

### DESCRIPTION OF THE PREFERRED EMBODIMENTS

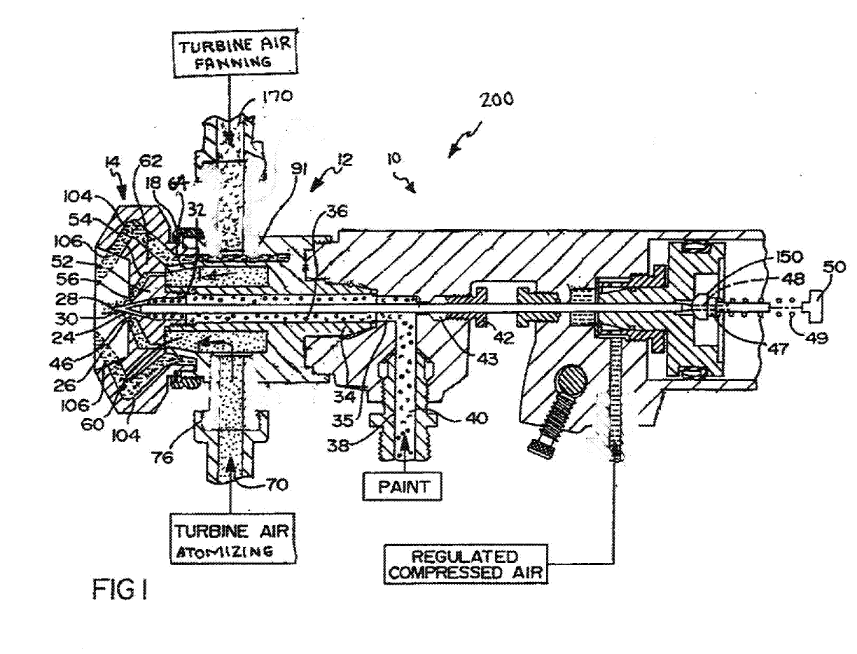

Referring to FIG. 1, a spray gun 200 embodying the present invention comprises an improvement on the spray gun embodiments shown and described in the aforementioned Toth U.S. Pat. No. 5,080,285. The spray gun 200 according to this invention includes certain of the features shown and described in the embodiments of the Toth '285 patent and the same numbers will be used herein to refer to or describe common structure and function incorporated into the spray gun 200.

In a preferred embodiment according to this invention, the spray gun 200 includes a main housing designated generally at 10, a generally cylindrical or tubular extension 12 secured to the forward end of the housing 10, the extension including a forwardly projecting hollow tubular member 34, and an air cap 14 having a rearward end mounted on the front end of the extension 12.

As will be detailed herein, the air cap 14 is adapted to receive and discharge paint from the spray gun and direct turbine air at the spray both for atomizing and forming the paint discharged into a conical spray and fanning the conical shape into a thin elliptical configuration.

The forward end of the air cap 14 includes a nozzle 24 and a central or discharge opening 26, the nozzle projecting coaxially through the central or discharge opening 26. The nozzle 24 is formed with a forwardly convergent tapered or conical bore 28 which terminates at an orifice 30 at the front end thereof. The nozzle 24 includes a threaded shank 32 which is threadably received within the forward end of tubular member 34 of the extension 12.

The tubular member 34 includes a central passage 36 that communicates with a bore 35 formed in the main housing 10.

Paint under pressure is supplied to the central passage 36 via a first fitting 38 threadably connected to the housing 10.

The rear or right hand end of the central passage 36 is closed by a packing 43. A threaded plug 42 slidably supports and guides an elongate rod-like needle valve 44 having a tapered forward end 46, which may be seated in the tapered or conical bore 28 of nozzle 24, to close the orifice 30.

The gun hereof, also, includes a “trigger” which is regulated by compressed air, as described below. The trigger includes a piston 150 axially mounted within the housing 10 to engage an enlarged diameter portion of an adjustable locknut 48 threaded on needle valve 44 to draw the valve to the right as viewed in FIG. 1 when air pressure is applied in a conventional manner. The needle valve 44 extends rearwardly past the piston 150 and continues through the housing 10 to be coupled to an adjustment knob 50 mounted within the housing.

A spring loaded coupling 47 is disposed between the needle valve 44 and the adjusting knob 50, such as spring 49, of conventional construction which acts to continuously bias needle valve 44 in a forward manner to its closed seated position within the nozzle 24. The adjustment knob 50 essentially locates the end limit of the movement of the needle valve 44 in a rearward manner to establish a maximum opening of the nozzle 24 when the piston 150 is fully moved rearwardly via the compressed air source, against the force of spring 49.

The nozzle 24 is formed with a plurality of radially projecting wings 52 having radially outer ends lying on a cylindrical surface coaxial with the axis of the nozzle 24. The rearward side of the air cap 14 is formed with a counter bore 54 of a diameter such that the outer ends of the wings 52 of the nozzle are slidably received within the counter bore 54. The inner end of the counter bore 54 merges with an inclined conical bore 56, which extends from the counter bore 54 to pierce the front side of the air cap 14, thereby establishing a central or discharge opening 26 surrounding the forward tip of the nozzle 24. The inclination of the wall of the conical bore 56 and the inclination of the forward side of the nozzle 24 and the axial dimensions of the air cap 14 and the nozzle 24 define an air passage.

The nozzle 24 and the air cap 14 are assembled in the gun between the central or discharge opening 26 and a chamber 60 having an enlarged diameter counter bore at the rearward side of the air cap 14. The air passage extends from the central or discharge opening 26 through the space between the opposed incline of the conical bore 56 of the air cap 14 and into the nozzle 24, and thereafter through the spaces between adjacent wings 52 of the nozzle 24. This construction is more particularly described in U.S. Pat. No. 4,744,518, issued May 17, 1988 to Toth, the disclosure of which is hereby incorporated by reference, including the drawings.

The tubular housing extension 12 is formed with an annular wall 64 in its forward end of the same diameter as the mating member 62 in the air cap 14, and the wall 64 and the mating member 62 define the turbine air chamber 60. The turbine air chamber 60 is of a diameter larger than the outer diameter of bores 54 and 56 and is in communication therewith such that air passes through the chamber 60, into the bores 54, 56 and exits via the air cap 14 through an orifice 30.

Turbine air under pressure is supplied to the chamber 60 via an air supply passage of a second fitting 76 threaded into the extension 12. This turbine air provided via the second fitting 76 is used for atomizing paint discharged from the central or discharge opening of the air cap and generally into a conical spray. Preferably, the second fitting 76 is at the forward end of the spray gun and proximate the air cap 14.

According to a preferred embodiment of this invention, turbine air under pressure is supplied from the extension 12 to the air cap 14 for fanning the conical paint spray from the discharge bores 52, 54. Preferably, the turbine air is introduced at a forward end of the extension 12, proximate to the air cap 14, and opposite to the fitting 76 that receives turbine air for atomizing. This turbine air is used exclusively for directing air to the atomized paint being discharged from the discharge ports 106 of the air cap 14 whereby to effect a desired fanning of a conical spray.

In this regard, a passage 91 is formed between an outer annular ring 110 of the extension 12 and the internal annular wall 64.

According to this preferred embodiment of this invention, a third fitting 176 is threadably attached to the tubular extension 12 and delivers compressed turbine air through a passage 170 of the fitting 176 to the passage 91.

The forward location of the third fitting 176 operates to increase the velocity of air through the passage 104.

Unexpectedly, by the configuration of the passageway 91 and location of the third fitting 176 herein, the fan dimension can be increased by as much as four inches, without splattering or developing paint droplets and obviates poor surface appearance or paint waste. This is a significant cost reduction in a typical paint situation.

It is to be appreciated that the preferred embodiment of the paint spray gun of the present invention utilizes turbine air both for atomizing as well as for fanning, to provide a low pressure, high volume system.

Likewise, paint and turbine air are admixed in the nozzle 24 and delivered. However, in accordance with this embodiment, turbine air is employed both to control atomizing and fanning. The turbine air is heated to a high volume and a low pressure and delivered from a remote source (not shown) into the chamber 60 and passageway 91.

In this embodiment, no adjustment rod is used to control the amount of turbine air delivered through the port 106 after passing through the passageway 91 of the tubular extension 12. Rather, only a turbine at high volume and low pressure is employed, which is regulated by a simple ball valve (not shown).

By employing all turbine air in this embodiment, there is still further provided a low pressure, high volume paint spray gun. For example, the turbine air at about 7 psig entering passage 91 will exit port 106 at about 6 psi, but at a volume of about 5-6 cfm.

It should be noted that the axial movement of the trigger piston 150 is accomplished with compressed air which is delivered through a fitting 71. However, it is solely turbine air which controls the atomizing and fanning of the paint discharged. The construction hereof enables a paint spray gun to operate efficiently between about ¼ psi and up to about 10 psi.

Operating Parameters: This is a typical example of the operating parameters for the automatic paint spray gun of the present invention, wherein turbine air is used for both atomizing and fanning.

| | Atomizing Air Supply | Fanning Air Supply |
|---|---|---|
| Pressure Range | 1-10 psi | 1-10 psi |
| Flow Rate | 1-20 cfm | 1-10 cfm |
| Temp. Range | Ambient 5° F.-160° F. | Ambient 5° F.-160° F. |
| Discharge Orifice | ⅝-¾ inch ID | 2 mm-5 mm |
| Hose Length Range | 4-60 feet | 4-60 feet |
| Control Means | High Flow Ball Valve | High Flow Ball Valve |

Atomizing air and fanning air are flowing at all times independent of fluid discharge. Additional solenoid valves can be placed upstream from the pressure control ball valve to prevent the constant air bleeding if required. These must be opened just prior to triggering the fluid flow from the nozzle to inside adequate atomization of paint at the beginning of discharge from the nozzle orifice.

While the paint spray gun of the present invention has been described in conjunction with a specific embodiment, it is evident that many alternatives, modifications, and variations will be apparent to those skilled in the art in light of the disclosure herein. It is intended that the metes and bounds of the invention be determined by the appended claims, rather than by the language of the above specification, and that all such alternatives, modifications, and variations which form a functional or conjointly cooperative equivalent are intended to be included within the spirit and scope of these claims.

### LIST OF REFERENCE NUMERALS

10 Housing
12 Tubular Extension
14 Air Cap
24 Nozzle
26 Central or Discharge Opening
28 Tapered Bore or Conical bore
30 Orifice
32 Threaded Shank
34 Tubular Member
35 Bore
36 Central Passage
38 First Fitting
42 Threaded Plug
43 Packing
44 Needle Valve
47 Spring loaded coupling
48 Locknut
49 Spring
50 Adjustment knob
52 Wings
54 Counter bore
56 Conical bore
60 Air chamber
62 Mating member
64 Annular wall
71 Fitting
76 Fitting
91 Passage
104 Passage
106 Port
110 Annular ring
150 Piston
170 Passage
176 Fitting

1. An HVLP paint spray gun, comprising:
(a) a housing;
(b) a tubular extension mounted onto the housing and having a first passageway;
(c) an air cap mounted on the tubular extension for discharging paint, the air cap having a nozzle in communication with the first passageway;
(d) a central paint discharge opening for directing turbine air at the discharging paint;
(e) a first source of turbine air for delivering atomizing turbine air to the air cap for the discharging paint; and
(f) a second source of turbine air for delivering fanning air to the air cap and being directed at the discharged paint.

2. The HVLP paint spray gun of claim 1, which further comprises:
a trigger and a source of compressed air; the compressed air for regulating the trigger; the trigger for controlling paint delivered through the first passageway to the air cap.

3. The HVLP paint spray gun of claim 1 wherein:
the nozzle has a plurality of radially projecting wings having outer ends disposed on a cylindrical surface; the surface being coaxial with the axis of the nozzle.

4. The HVLP paint spray gun of claim 1 wherein:
the tubular extension includes a turbine air chamber in fluid communication with the air cap, turbine air passing from the chamber through the air cap atomizes paint discharged through the central opening.

5. The HVLP paint spray gun of claim 1, which further includes:
a passageway for delivering compressed fanning turbine air to the already atomized paint.

6. The HVLP paint spray gun of claim 5, wherein:
the fanning air passageway is provided at the forward end of the tubular extension proximate the air cap at a location on the tubular extension to a position opposite to that of the atomizing turbine air.
